(19) United States
(12) Patent Application Publication
(10) Pub. No.: US 2010/0171977 A1
(43) Pub. Date: Jul. 8, 2010

(54) PRINTING SYSTEM AND PRINTING METHOD

(75) Inventor: HUO-PING FU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/498,746

(22) Filed: Jul. 7, 2009

(30) Foreign Application Priority Data
Jan. 5, 2009 (CN) 200910300039.4

(51) Int. Cl. G06F 3/12; G06F 15/16

(52) U.S. Cl. 358/1.15; 709/203; 715/274

(57) ABSTRACT

A printing system includes a printer and a printer server connected to the printer. The printer server is installed with a printer driver for driving the printer. The printer server includes a web control module and a print module. The control module provides a user interface (UI) to a connected client. The control module is capable of receiving a first file in an original format from the client and transmitting the first file to the print module. The print module is capable of transforming the first file in the original format to a second file in a format printable by the printer.

### BACKGROUND

1. Technical Field

The disclosure generally relates to a printing system and a printing method through a printer server.

2. Description of Related Art

In computers, a printer driver is software that can convert the data to be printed to the form specific to a printer. The purpose of printer drivers is to allow applications to do printing without being aware of the technical details of each printer model. The printer drivers usually need to be installed in user's computers before printing. The user may use various different operating systems, such as Windows™, or Unix™, etc. These operating systems must be installed with different printer drivers to realize printing operations.

### BRIEF DESCRIPTION OF THE DRAWINGS

FIG. 1 is a schematic view of a printing system showing a connection among a printer, a printer server and a plurality of clients.

FIG. 2 is a block view of the printing system.

FIG. 3 is a schematic view of a user interface for setting print configuration.

FIG. 4 is a flowchart of a printing method.

### DETAILED DESCRIPTION

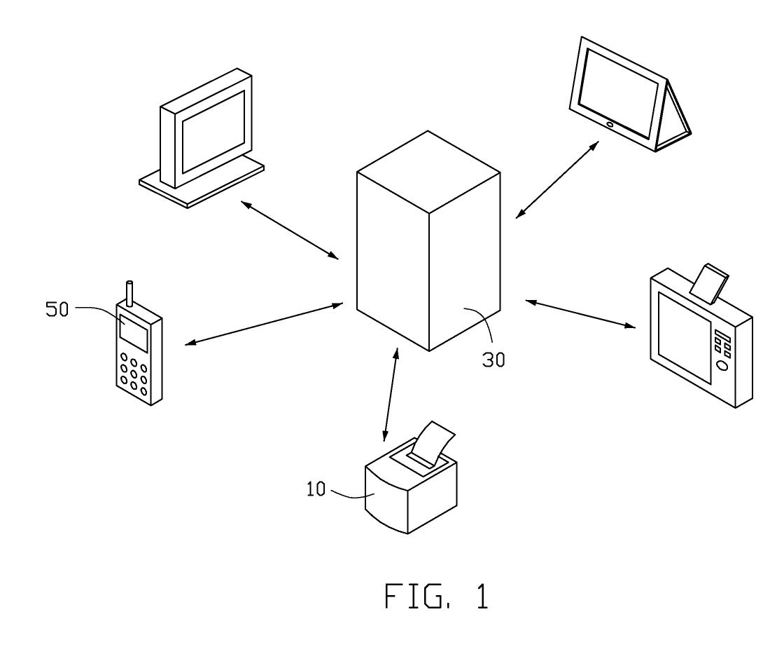

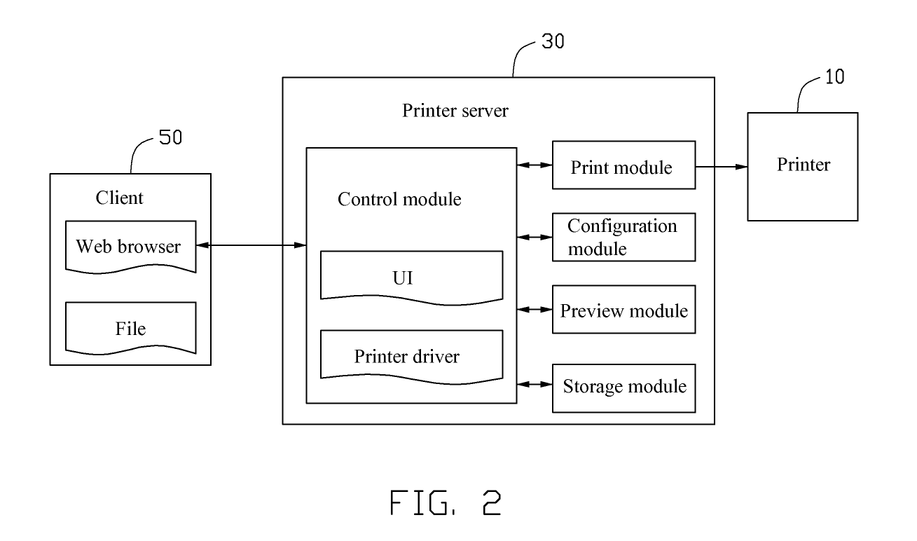

Referring to FIG. 1 and FIG. 2, a printing system in an embodiment includes a printer 10 and a printer server 30. The printer server 30 is connected to the printer 10. At least one client 50 may be connected to the printer server 30 through a wireless connection, such as Wi-Fi™ based on the IEEE 802.11 standards. The client 50 may be connected to the printer server 30 through the Internet or an intranet. The client 50 may be one of a computer, a digital media frame, a mobile phone, or other electronic device. The printer server 30 and the printer 10 may be remote from the client 50.

The client 50 is installed with a web browser and stores a to-be-printed file.

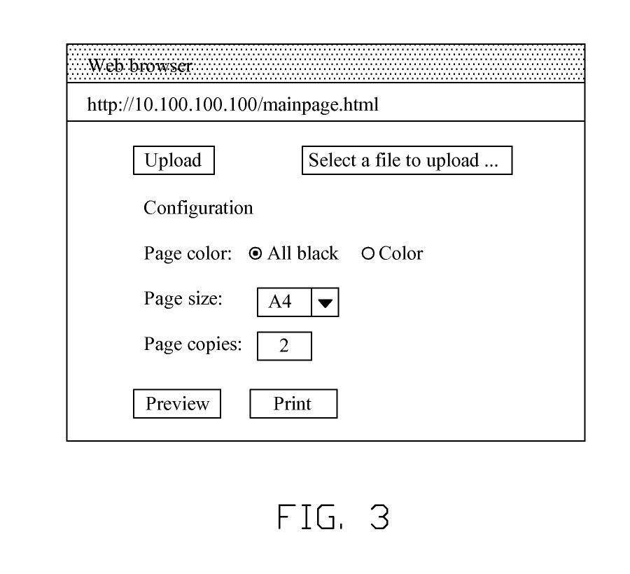

The printer server 30 includes a control module. The control module has a user interface (UI) for controlling printing operations and a printer driver for driving the printer 10. The UI is constructed using Hypertext Mark-up Language (HTML), and is assessable through the web browser of the client 50 based on the TCP/IP protocol. A display effect is shown in FIG. 3, when the printer server 30 is accessed through the web browser of the client 50, a main page of the UI is shown on the client 50. A user may select a print configuration for the to-be-printed file.

A print module, a configuration module, and a preview module are connected to the control module. The print module is capable of outputting data to the printer 1O. The preview module is capable of previewing the to-be-printed file before printing. The configuration module is capable of performing print configurations by the client 50 through the UI. A storage module, such as a hard disk, a cache or a flash, is connected to the control module to store the to-be-printed file from the client 50.

The control module is capable of receiving a first file with an original format from the client 50 and transmitting the first file to the print module. The print module is capable of transforming the first file in the original format to a second file in a format printable by the printer 10. The printer 10 is capable of directly printing the second file.

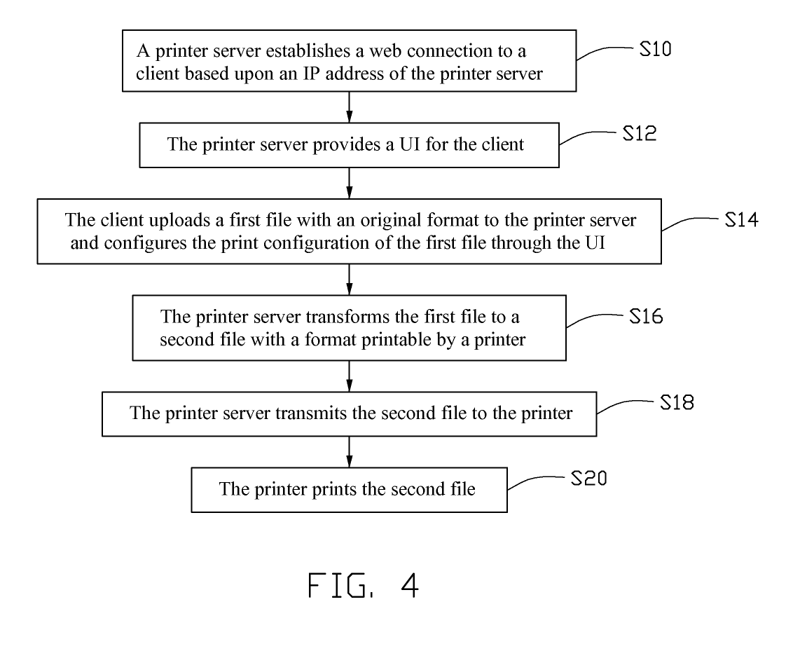

Referring to FIG. 4, a printing method includes the following steps.

S10: a printer server 30 establishes a web connection to a client 50 based upon an IP address of the printer server 30.

S12: the printer server 30 provides a UI for the client 50.

S14: the client 50 uploads a first file in an original format to the printer server 30 and configures the print configuration of the first file through the UI. The printer server 30 previews the first file.

S16: the printer server 30 transforms the first file to a second file in a format printable by a printer 10.

S18: the printer server 30 transmits the second file to the printer 10.

S20: the printer 10 prints the second file.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A printing system comprising:
a printer; and
a printer server connected to the printer, the printer server being installed with a printer driver for driving the printer, the printer server comprising a web control module and a print module; the control module being capable of providing a user interface (UI) to a connected client, receiving a first file in an original format from the client, and transmitting the first file to the print module; and the print module is capable of transforming the first file in the original format to a second file in a format printable by the printer.

2. The printing system of the claim 1, wherein the control module is capable of receiving the first file through a wireless connection.

3. The printing system of the claim 1, wherein the control module is capable of being accessed through a web browser of the client.

4. The printing system of the claim 1, wherein the UI is constructed using Hypertext Mark-up Language.

5. The printing system of the claim 1, wherein the printer server further comprises a preview module, and the preview module is capable of previewing a to-be-printed file before printing.

6. The printing system of the claim 1, wherein the printer server further comprises a storage module for storing the first file from the client.

7. The printing system of the claim 1, wherein the printer server further comprises a configuration module capable of performing print configurations by the client.

8. A printing method comprising:
a printer server establishing a web connection to a client;
the printer server providing a user interface (UI) for the client;
the printer server receiving a first file in an original format from the client through the UI;
the printer server transforming the first file to a second file in a format printable by a printer; and
the printer server transmitting the second file to the printer.

9. The method of claim 8, wherein the printer server is accessible through a web browser based upon an IP address of the printer server.

10. The method of claim 8, wherein the printer server is able to accept a wireless connection.

11. The method of claim 8, wherein the UI is constructed using Hypertext Mark-up Language.

12. The method of claim 8, wherein the printer server previews the first file before transmitting the second file to the printer.

13. The method of claim 8, wherein the printer server configures the first file before transmitting the second file to the printer.
